(19) United States
(12) Patent Application Publication
(10) Pub. No.: US 2019/0218860 A1
(43) Pub. Date: Jul. 18, 2019

(54) LADDER BUMPER

(71) Applicant: JLS PAINTING, LLC, Meridian, ID (US)

(72) Inventor: John L. Seabold, Meridian, ID (US)

(21) Appl. No.: 16/365,472

(22) Filed: Mar. 26, 2019

Related U.S. Application Data
(63) Continuation-in-part of application No. 15/589,654, filed on May 8, 2017.
(60) Provisional application No. 62/333,207, filed on May 7, 2016.

(51) Int. Cl. E06C 7/48; E06C 7/46

(52) U.S. Cl. CPC E06C 7/48; E06C 7/46

(57) ABSTRACT

A ladder rail channel for use with a ladder can protect surfaces against which the ladder is placed and enhance safety of the ladder. Embodiments of ladder rail channels comprise a generally U-shaped elongate rail channel formed by a channel web and a pair of opposing channel legs. Embodiments of ladder rail channels include a protective pad affixed snugly to the channel web. In use, rail channels may each be seated on ladder rails. The rail channels can be locked in position by a spring tension holding force on the ladder rails and/or ladder rail flanges.

### CROSS-REFERENCE TO RELATED APPLICATIONS

The present application claims the filing date benefit of U.S. patent application Ser. No. 15/589,654, filed May 8, 2017, and of U.S. Provisional Patent Application No. 62/333,207, filed May 7, 2016, the contents of both applications being hereby fully incorporated by reference.

### BACKGROUND

### Technical Field

This disclosure is directed generally to bumpers designed to be affixed to a ladder's rails, and more specifically to a new ladder bumper, embodiments of which assist placement of the ladder at a predetermined and preferably safe vertical angle.

### Description of Related Art

Improperly placed ladders can be dangerous to the climber. OSHA requires that a ladder be placed at about 75.5 degrees to the horizontal against a structure for optimum safety against the ladder falling. OSHA further requires that the ladder extend 3 feet past the top step-off point from the ladder (e.g. the roof eave, or roof line, when used to climb onto a conventional building roof). It is not always easy to set the ladder at the correct length to enable the OSHA-recommended horizontal angle and extension. It is further not always easy to estimate visually whether the ladder placement meets the OSHA-recommended horizontal angle and extension. While the placement's horizontal angle and extension can be measured, this can be time consuming and requires “trial and error” until the correct placement is established.

Further, the mere placement of ladders against a structure can cause contact damage to the structure, especially at the point of contact between the ladder and the structure near the top of the ladder. The damage can be made worse if the ladder is moved and sliding occurs at the point of contact between the ladder and the structure. For example, such damage is commonplace when conventional ladders (e.g. wood or aluminum) are used to scale structures such as residential or commercial buildings. Damage may be sustained at contact points such as gutters, walls, window sills, doors, or garage doors, for example. Likewise, damage may be sustained during transportation of the ladder in or on a vehicle.

Surfaces on which the bottom of a placed ladder rests may also be potentially unsafe. While surfaces such as concrete are generally satisfactory when other OSHA-recommended parameters are met (e.g. correct horizontal angle and extension), optimum ladder placements do not always provide a bottom surface such as concrete. Soft or uneven surfaces (e.g. unpaved ground) may cause the bottom of a placed ladder to be potentially unstable, calling into the question the entire stability of the ladder in use.

There is therefore a need for ladder accessories, primarily including a new ladder bumper, that address the foregoing drawbacks.

### SUMMARY

In one embodiment, a ladder rail channel is disclosed. The ladder rail channel includes two opposing elongate channel legs, an elongate channel web, and a protective pad affixed to the ladder rail channel. The two channel legs are separated by and connected to the elongate channel web. The two channel legs comprise a first channel leg and a second channel leg. The first channel leg comprises a proximal section proximate to the channel web, a distal section situated away from the channel web, and an intermediate transition section situated between and joining the proximal section and the distal section. The proximal section defines a proximal clearance gap between the proximal section and the second channel leg. The distal section defines a distal clearance gap between the distal section and the second channel leg. The clearance gap of the distal section is smaller than the proximal clearance gap. The protective pad is affixed to the ladder rail channel on a surface of the channel web opposite the two channel legs.

In another embodiment, a pair of ladder rail channels and a ladder are disclosed. The ladder includes two ladder rails and a protective pad. Each ladder rail channel includes two opposing channel legs separated by and connected to a channel web. The two channel legs comprise a first channel leg and a second channel leg. The first channel leg is adapted to apply spring tension toward the second channel leg to grip one of the ladder rails. The protective pad is affixed to the channel web such that the pad contacts the channel web. Each ladder rail channel is seated on a corresponding one of the ladder rails.

In another embodiment, a method of using a ladder is disclosed. The method includes providing two ladder rail channels and a ladder. The ladder includes two ladder rails separated by a plurality of spaced-apart ladder rungs. The method further includes seating a first one of the two ladder rail channels on a first one of the two ladder rails. Each ladder rail has two opposing flanges along its length. Each ladder rail channel includes two opposing elongate channel legs separated by and connected to an elongate channel web. The two channel legs comprise a first channel leg and a second channel leg. The first channel leg has a proximal section proximate to the channel web, a distal section situated away from the channel web, and an intermediate transition section situated between and joining the proximal section and the distal section. The proximal section defines a proximal clearance gap between said proximal section and the second channel leg. The distal section defines a distal clearance gap between said distal section and the second channel leg. The clearance gap of the distal section is smaller than the proximal clearance gap. Seating the first ladder rail channel on the first ladder rail includes positioning the first ladder rail channel onto the first ladder rail such that the first ladder rail is placed between the first channel leg and the second channel leg of the first ladder rail channel, applying a seating force on the first ladder rail channel toward the first ladder rail, thereby causing a corresponding first one of the two opposing flanges of the first ladder rail to slide past the distal section of the first channel leg of the first ladder rail channel and push against the first channel leg of the first ladder rail channel while a corresponding second one of the two opposing flanges of the first ladder rail pushes against the second channel leg of the first ladder rail channel, thereby causing the first channel leg of the first ladder rail channel to flex away from the first flange of the first ladder rail, and continuing to apply the seating force on the first ladder rail, thereby causing the first channel leg of the first ladder rail channel to spring to a locked position, whereby the first channel leg of the first ladder rail applies a spring tension holding force upon the first flange of the first ladder rail, thereby securing the first ladder rail channel to the first ladder rail.

The present disclosure will now be described more fully with reference to the accompanying drawings, which are intended to be read in conjunction with both this summary, the detailed description, and any preferred or particular embodiments specifically discussed or otherwise disclosed. This disclosure may, however, be embodied in many different forms and should not be construed as limited to the embodiments set forth herein; rather, these embodiments are provided by way of illustration only so that this disclosure will be thorough, and fully convey the full scope of the disclosure to those skilled in the art. Non-limiting and non-exhaustive embodiments of the present disclosure are described with reference to the following figures, wherein like reference numerals refer to like parts throughout the various views unless otherwise specified.

### BRIEF DESCRIPTION OF THE DRAWINGS

Non-limiting and non-exhaustive embodiments of the present disclosure are described with reference to the following figures.

FIGS. 1A, 1B, and 1C illustrate various views of an embodiment of protective pad 100 including angle-setting protrusion (“ASP”) 110;

FIGS. 2A and 2B illustrate protective pad 100 as shown in FIGS. 1A through 1C in assembly with rail channel 200;

FIG. 3 illustrates two different embodiments of protective pad 100 and 100A, including different embodiments of ASP 110 and 110A;

FIGS. 4A and 4B illustrate rail channel .200A, an alternative embodiment to rail channel 200 in assembly with protective pad 100;

FIG. 5 illustrates one embodiment of a suitable U-bolt lock 300;

FIG. 6 illustrates deployment of the disclosed ladder bumpers on a conventional ladder in which ASP 112 operates to set the desired ladder angle 119;

FIG. 6A is an exploded isometric view of the base of FIG. 6 showing insertion of ladder stake 400 in more detail;

FIGS. 7A and 7B illustrate an embodiment of the disclosed ladder bumper in use with a conventional ladder;

FIG. 8 is a perspective view of a ladder rail channel according to one embodiment of the present disclosure;

FIG. 9 is a detail perspective view of an end of a ladder rail channel end portion according to one embodiment of the present disclosure;

FIG. 10 is a section view of a ladder rail channel according to one embodiment of the present disclosure;

FIG. 11 is a section view of a ladder rail channel seated on a ladder rail according to one embodiment of the present disclosure; and

FIG. 12 is a perspective view of a pair of ladder rail channels seated on a ladder according to one embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, reference is made to exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples.

Embodiments of the present disclosure comprise a bracket adapted to attach to a ladder rail. In some embodiments, said bracket comprises two opposing bracket arms, each arm being adapted to grip a respective side of the ladder rail to secure said bracket to said ladder rail. Embodiments of the present disclosure comprise a pad secured to an exposed surface of the rail, such that

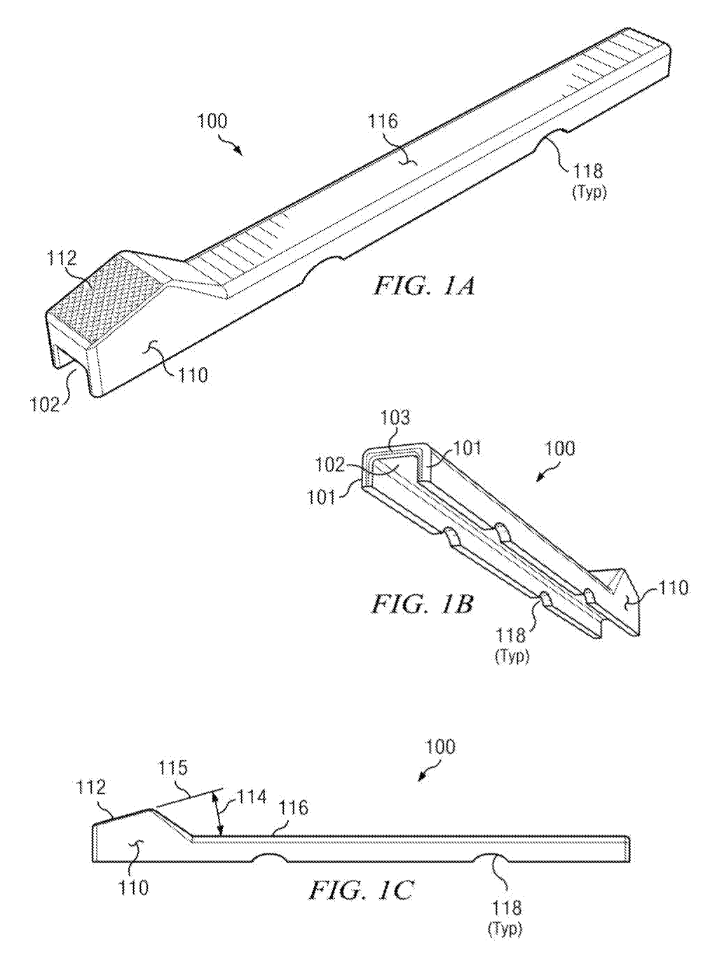

FIGS. 1A, 1B, and 1C illustrate various views of an embodiment of protective pad 100. FIG. 1B depicts protective pad 100 having a generally U-shaped cross section in which two generally opposing and parallel pad legs 101 are separated by and connected to pad web 103. FIG. 1B also shows recess 102 formed by pad legs 101 and pad web 103. As shown in FIGS. 1A and 1C, pad web 103 provides a pad web planar surface 116. FIGS. 1A and 1B depict protective pad 100 having first and second protective pad ends, with a pad web thickened portion 104 provided on pad web 103 towards the first protective pad end. Referring now to FIGS. 1A and 1C, pad web thickened portion 104 includes an angle-setting protrusion (ASP) 110. ASP 110 includes ASP planar surface 112, such that ASP planar surface 112. and pad web planar surface 116 subtend a predetermined ASP angle 114.

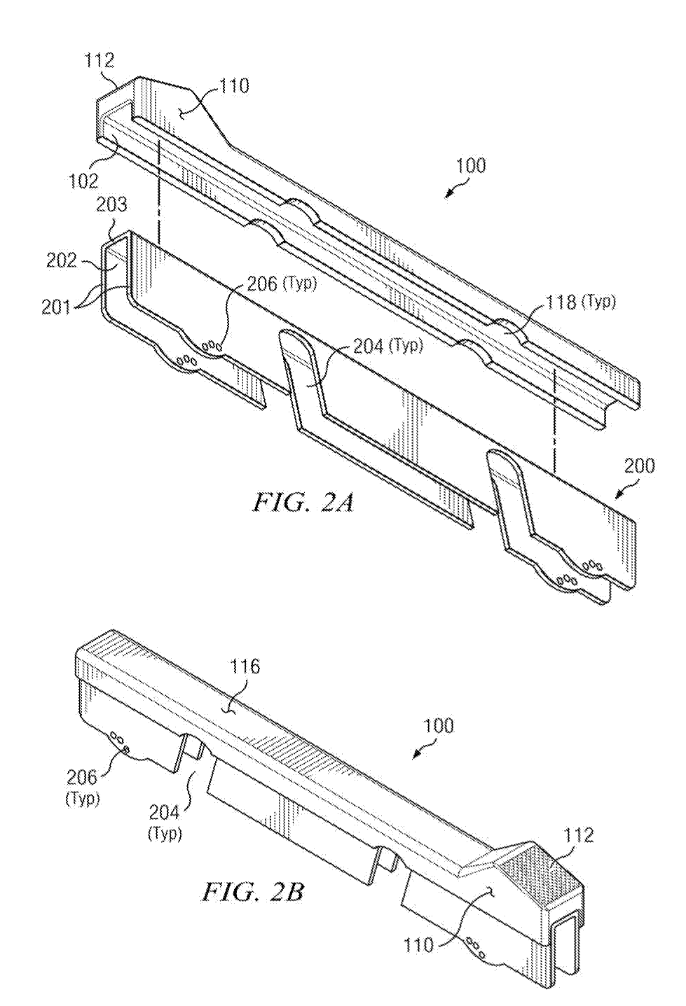

Referring now to FIG. 2A, an exploded view of protective pad 100 and rail channel 200 is depicted. Similar to protective pad 100 as described above, rail channel 200 rail channel has a generally U-shaped cross section in which two generally opposing and parallel channel legs 201 are separated by and connected to a channel web 203. Channel space 202 is formed by channel legs 201 and channel web 103. FIG. 2A further depicts rail channel 200 having first and second rail channel ends such that the first protective pad end on protective pad 100 is oriented towards the first rail channel end on rail channel 200.

In the embodiment illustrated in FIGS. 2A and 2B, rail channel 200 provides two opposing pairs of rung slots 204. One rung slot 204 in each opposing pair thereof is provided in a corresponding channel leg 201. Each rung slot 204 further provides a rung slot opening 205, such that opposing pairs of rung slots 204 follow a path from their rung slot openings 205 generally in the direction of the first rail channel end.

FIG. 2B illustrates protective pad 100 received over and affixed snugly to rail channel 200 such that (with additional reference to FIG. 2A) pad web 103 contacts channel web 203.

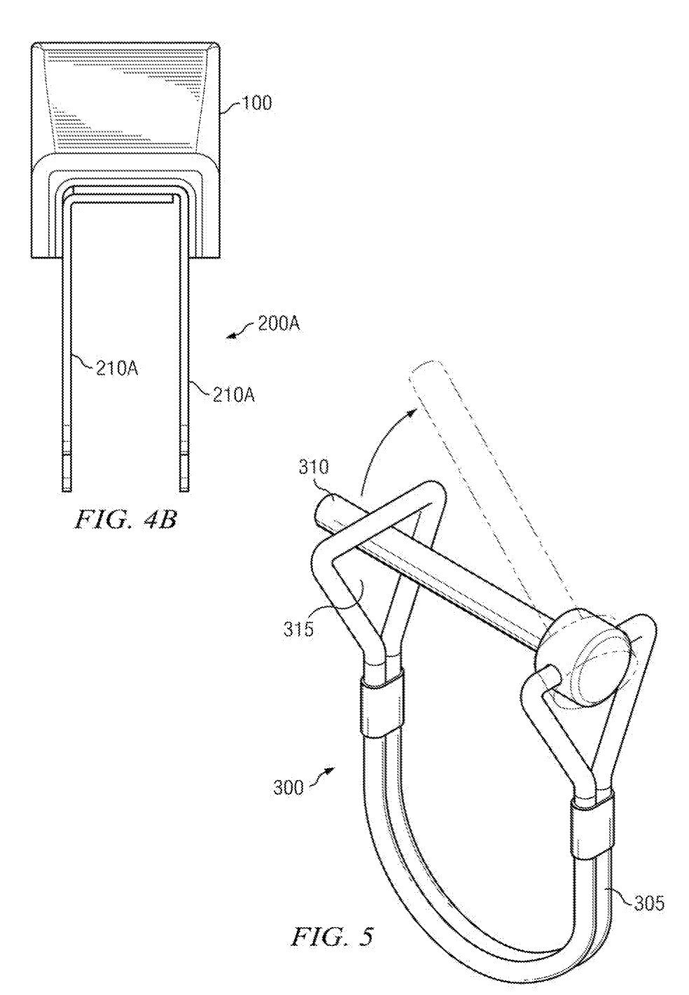

Referring to the embodiments illustrated in FIGS. 2A and 2B in more detail, rail channel 200 may be any suitable generally U-shaped profile member, or a combination of members. This disclosure is not limited to any particular construction of rail channel 200, and may be for example, a unitary channel member, or an assembly of 2 angle members (an example of which is described below with reference to FIGS. 4A and 4B), or another design. Rail channel 200 is preferably made of metal, and more preferably aluminum, although again this disclosure is not limited in this regard. Other materials for rail channel 200 may be suitable, depending on application and user design. Preferably, the width and depth of channel space 202 in rail channel 200 is selected so that rail channel 200 slides comfortably over the rail of a conventional ladder.

As depicted in FIG. 2A, preferably two opposing pairs of rung slots 204 (i.e. four rung slots 204 total) are provided in channel legs 201 for engagement either side of two adjacent rungs on a conventional ladder. Two opposing pairs of rung slots 204 may offer optimum stability when engaged on a ladder in view of design length and weight of the rail channel 200. However, this disclosure is not limited in this regard. Two rung slots 204 (engaging either side of one rung) may be provided in other embodiments, or six or more (engaging either side of three or more rungs) may be provided in yet further embodiments, depending on user design. Similarly, although the embodiment illustrated in FIG. 2A provides rung slots 204 for adjacent ladder rungs, this disclosure is not limited to adjacent ladder rungs. The scope of this disclosure includes other embodiments where rung slots 204 engage ladder rungs that are not adjacent.

It will be further appreciated from FIG. 2A that the path of rung slots 204 is preferably straight and shaped to follow a direction from rung slot openings 205 towards the first rail channel end. Preferably this allows rung slots 204 to fully engage the ladder rungs and then to be secured in place in part by gravitational force when the ladder is upright. This feature may enhance the stability and locking advantage of the disclosed ladder bumper when in use on an upright ladder. The scope of this disclosure is not limited, however, to particular paths that rung slots 204 may follow in channel legs 201, and alternative embodiments (not illustrated) may include straight or curved paths, all preferably following a direction from rung slot openings 205 towards the first rail channel end.

FIGS. 2A and 2B further illustrate locking pin holes 206 provided in rail channel 200. Locking pin holes 206 are configured to receive U-bolt locks (described below with reference to FIG. 5) in order to retain rail channel 200 on the ladder rail once rail channel 200 is fully engaged on the ladder rail and rungs. Preferably, locking pin holes 206 are provided in a group, allowing a user to select an optimum locking pin hole 206 through which to receive the U-bolt lock according to the individual fit of rail channel 200 over a particular ladder rail.

As noted above, FIG. 2A illustrates protective pad 100 in exploded view with rail channel 200 and FIG. 2B illustrates protective pad 100 received over and affixed snugly to rail channel 200. Fixation of protective pad 100 to rail channel 200 may be by any conventional technique, such as with adhesive and/or with fasteners, for example. This disclosure is not limited in this regard. As shown in FIGS. 2A and 2B, recess 102 in protective pad 100 mates with channel web 203 and portions of channel legs 201. Where needed, protective pad 100 also provides cutouts 118 to cooperate with rung slots 204 on rail channel 200, to ensure that protective pad 100 does not impede full engagement of the ladder rungs on rung slots 204. As described above in the Summary section, this disclosure is not limited to any particular selection of materials for protective pad 100, although preferably the material thereof is resilient and durable, such as, for example, rubber or Styrofoam.

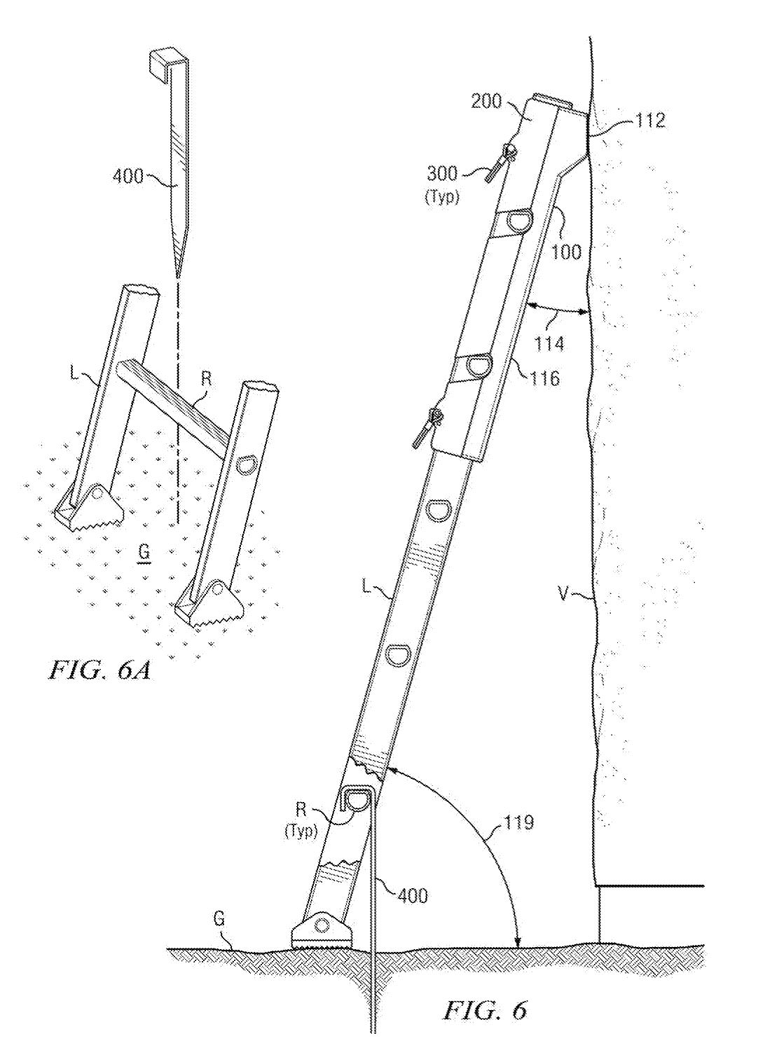

With reference now to FIG. 6, and as described generally in the Summary section above, the disclosed ladder bumpers are shown installed and engaged on a ladder's rails L and rungs R. Planar surfaces 112 on ASPs 110 confront a substantially vertical upper contact surface V on the structure against which the ladder is to be laid. In this depiction, the ladder is standing on a substantially horizontal ground surface G. From FIG. 1C, the predetermined ASP angle 114 on ASP 110 in FIG. 6 is now such that when planar surface 112 is brought into snug contact against the structure's contact surface V, the ladder will be set against the structure at a user-desired ladder angle 119. The value of ladder angle 119 may be about 90 degrees minus ASP angle 114. In preferred embodiments, predetermined ASP angle 114 is about 14.5 degrees, so that ladder angle 119 is about 75.5 degrees, thereby conforming to OSHA requirements. However, this disclosure is not limited to 14.5-degree/75.5-degree deployments for ASP angle 114 and ladder angle 119, respectively. ASP 110 on a particular protective pad 100 may be manufactured to set any predetermined ASP angle 114 as may be desired.

FIGS. 6 and 6A further illustrate the use of ladder stake 400 over rung R to anchor the ladder in place in ground G (where ground G is soft enough to receive ladder stake 400). Preferably, ladder stake 400 is installed once the desired ladder angle 119 has been set.

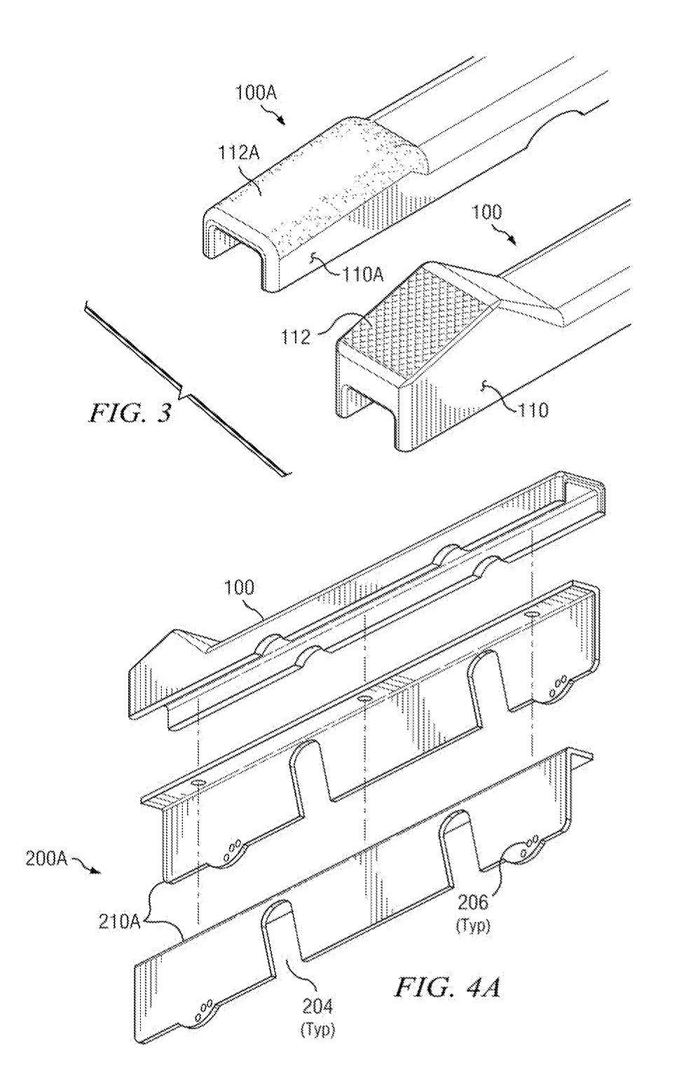

FIG. 3 illustrates two different embodiments of protective pad 100 (labeled 100 and 100A) with different dimensions, both overall in the protective pad 100/100A, and also on ASP 110/100A. FIG. 3 also illustrates that surfaces on protective pad 100/100A, including planar surface 112/112A, may be textured to offer additional slip resistance.

FIGS. 4A and 4B depict views of rail channel 200A, which is an exemplary alternative two-piece construction of rail channel 200 illustrated in FIGS. 2A and 2B. Per disclosure above associated with FIG. 2A, rail channel 200 may be any suitable generally U-shaped profile member, or combination of members, and this disclosure is not limited to any particular construction of rail channel 200. FIGS. 4A and 4B depict embodiments of rail channel 200A constructed from two angle members 210A fixed together by fasteners.

FIG. 5 illustrates one embodiment of a conventional U-bolt lock 300 that may be used in conjunction with locking pin holes 206 on rail channel 200 as illustrated in FIGS. 2A and 2B. In the embodiment of FIG. 5, U-bolt lock 300 comprises U-bolt frame 305, which may be manually widened (against spring bias provided by frame 305) to allow insertion or removal of U-bolt pin 310 into or out of U-bolt hole 315. U-bolt locks 300 may be commercially available from well-known fastener suppliers such as McMaster-Carr. It will be nonetheless appreciated that this disclosure is not limited to the illustrated embodiment of U-bolt locks 300, and that any suitable fastener may be used to lock rail channel 200 in place on the ladder rail.

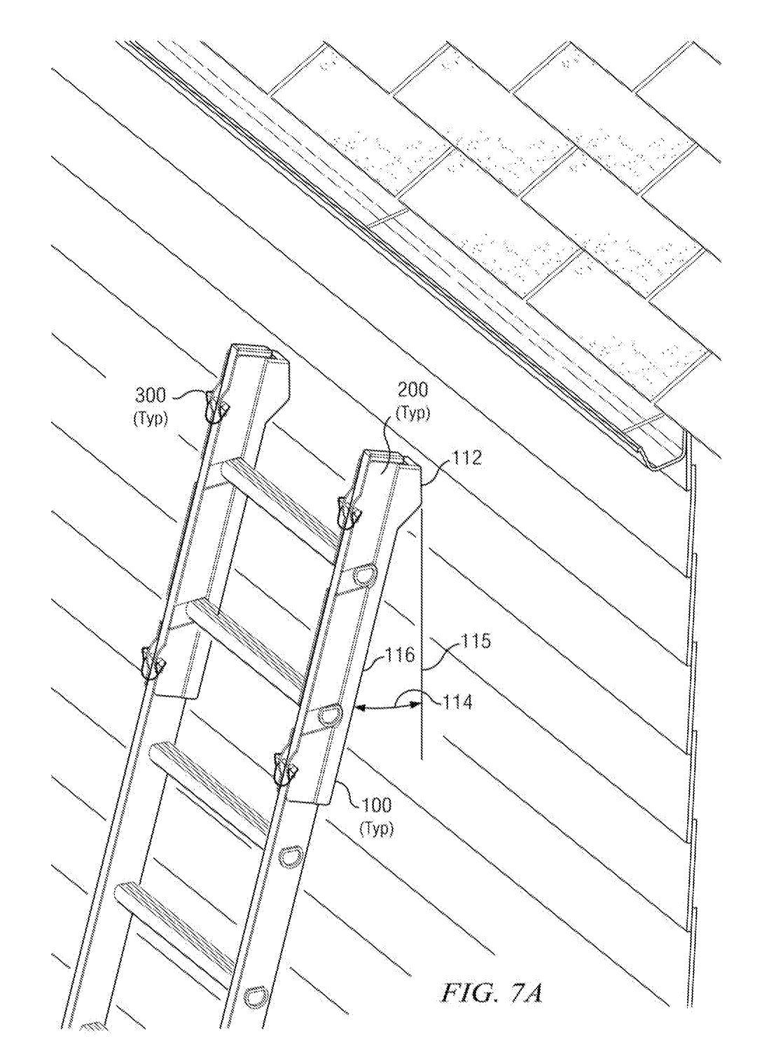

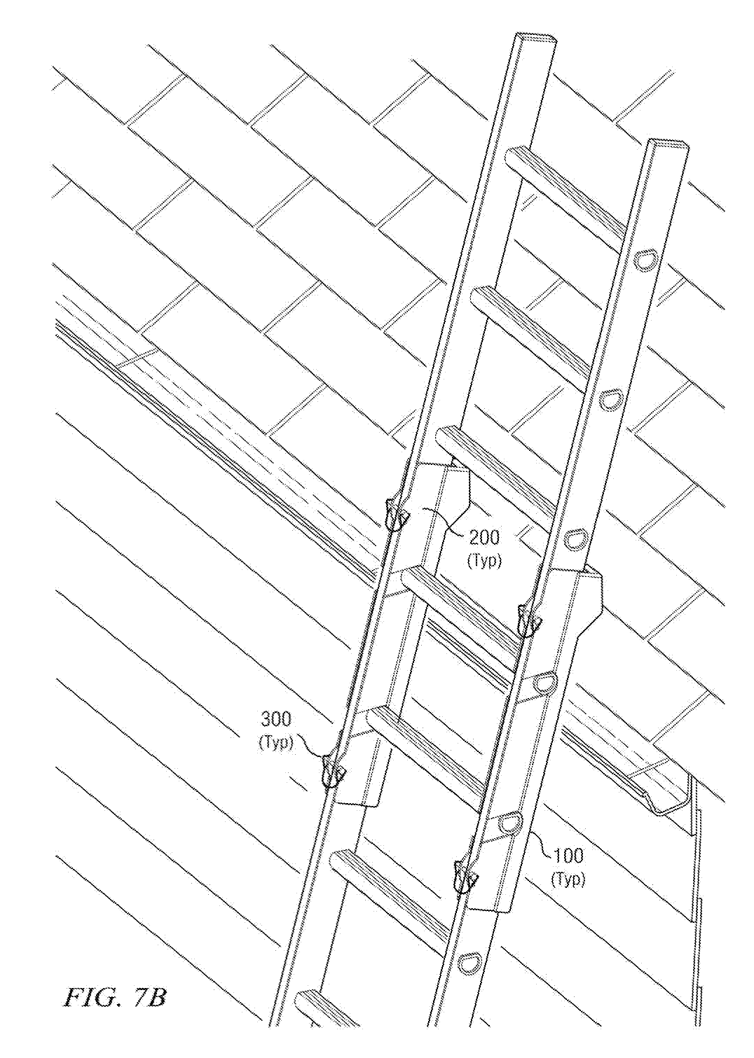

FIGS. 7A and 7B illustrate embodiments of the disclosed ladder bumpers in use on a conventional ladder. With additional reference to FIGS. 5 and 2A, it will be seen in FIGS. 7A and 7B that once the disclosed ladder bumpers are fully engaged on the ladder rungs and around the ladder rail, U-bolt pins 310 on U-bolt locks 300 may be passed through locking pin holes 206 on rail channel 200, thereby securely locking the ladder bumpers onto the ladder in the desired location. The U-bolt frame 305 of U-bolt lock 300 may also be used as a handle to assist manual fastening and unfastening of U-bolt lock 300. In embodiments using a U-bolt lock 300, once the bolt is fastened to secure rail channel 200, U-bolt frame 305 may then be laid down to rest flush against the ladder rail during ladder use.

FIGS. 7A and 7B further illustrate different positions on the ladder where the disclosed ladder bumpers may be placed according to circumstances and conditions of the current use of the ladder. In FIG. 7A, the disclosed ladder bumpers are located near the top end of the ladder, providing protection when the contact surface is, for example, the vertical side of a structure. In FIG. 7B, the disclosed ladder bumpers are located further down towards the base of the ladder when the contact surface is a roof line or a garage door, for example, where the ladder extends further upwards past the contact surface. FIG. 7A also illustrates the subtending of predetermined ASP angle 114 between ASP plane 115 and pad web planar surface 116 per earlier disclosure with reference to FIG. 1C and FIG. 6.

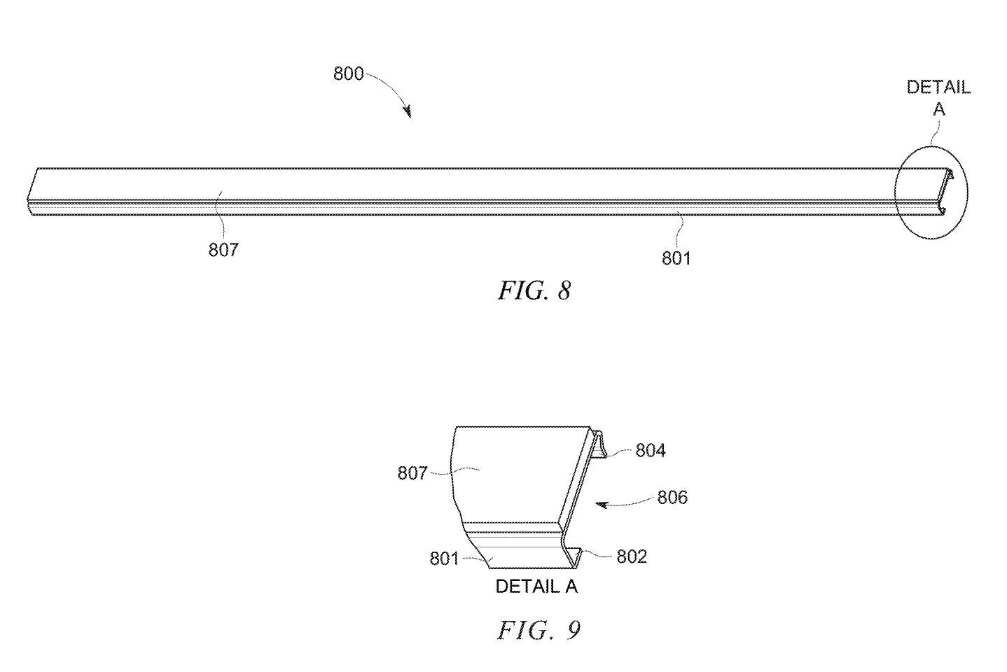

Referring now to FIGS. 8 and 9, one embodiment of a ladder rail channel 800 has a generally U-shaped cross section in which two generally opposing and parallel channel legs 801, 804 are separated by and connected to channel web 807. A channel space 806 is formed between legs 801, 804 and web 807. Channel web 807 provides a web planar top surface 808.

In various embodiments, rail channel 800 may be any suitable generally U-shaped profile member or a combination of members. This disclosure is not limited to any particular construction of rail channel 800, and may be for example, a unitary channel member, an assembly of two or more angle members, or another design. Rail channel 800 may be made of metal, including aluminum or steel, or other alloys, metals, other materials, or various combinations thereof. This disclosure is not limited in this regard. Other materials for rail channel 800 may be suitable, depending on application and user design. Preferably, the width and depth of channel space 806 in rail channel 800 is selected so that rail channel 800 slides snugly over the rail of a conventional ladder.

Embodiments of rail channel 800 comprise a variety of lengths. In one embodiment, rail channel 800 has a length of approximately 24 inches. In another embodiment, rail channel 800 has a length of approximately 12 inches. In another embodiment, rail channel 800 has a length between 12 and 24 inches. In another embodiment, rail channel 800 has a length between 24 and 36 inches. In other embodiments, rail channels may have virtually any length and still fall within the scope of this disclosure. As would be understood by a person of ordinary skill having the benefit of this disclosure, certain rail channel lengths may be more practical to allow for attachment of the rail channel to a ladder rail. As used in the present disclosure with respect to the length of a rail channel, the term “approximately” means within one inch of the stated length.

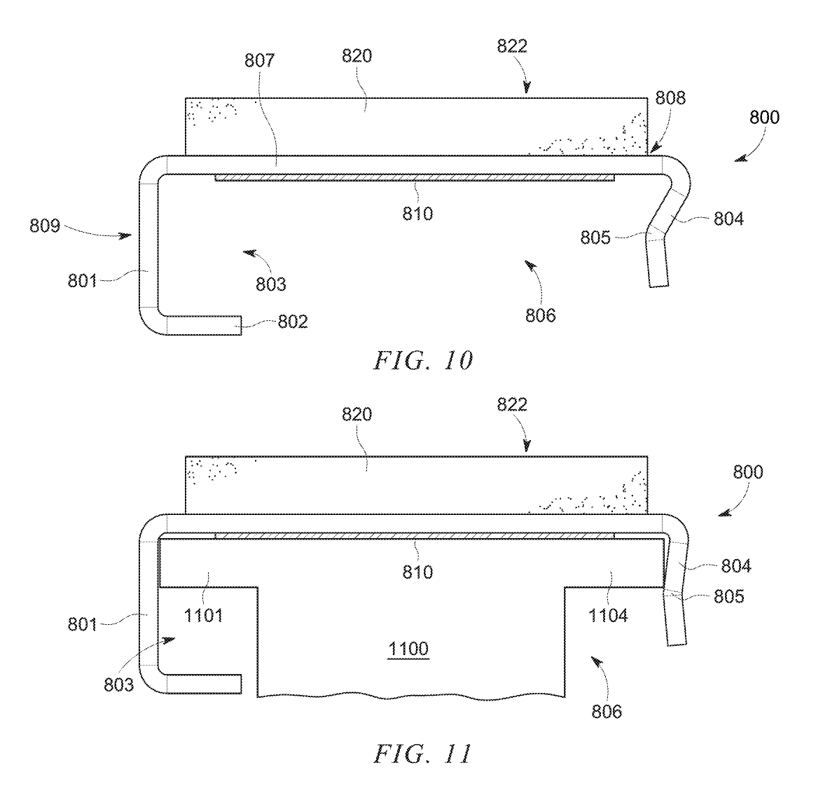

In embodiments, the distance between channel legs 801, 804 are such that each leg may grip opposing surfaces of a ladder rail on which rail channel 800 is seated by insertion of the ladder rail into channel space 806. Referring to FIG. 10, embodiments of channel leg 801 comprises an inward-facing leg extension 802 that, in combination with channel web 807, forms a channel 803 bounded in part by a C-shaped extension 809. In embodiments, the width and/or depth of said channel 803 is adapted to receive a ladder rail flange. When the ladder rail flange is thus positioned within the channel 803, inward-facing leg extension 802 can hold the rail channel 800 to the ladder rail flange.

In embodiments, channel leg 804 extends from web 807 at an acute angle. In one embodiment, channel leg 804 forms an angle of approximately 60 degrees with channel web 807. In other embodiments, channel leg 804 and channel web 807 form one of virtually any number of various angles. Embodiments of channel leg 804 function to allow rail channel 800 to act as a spring clip to securely attach to a ladder rail by applying a spring tension to said ladder rail by at least one channel leg 801, 804. Channel leg 804 comprises bend 805. In embodiments, bend 805 comprises a bend of approximately 145 degrees. In other embodiments, bend 805 comprises a bend having one of a variety of angles. In embodiments, channel leg 804 and bend 805 are adapted such that leg 804 can flex outward as a user applies a seating force upon rail channel 800 towards and relative to a ladder rail. As said force is applied to rail channel 800, a flange of said ladder rail may exert an outward force upon leg 804, thereby temporarily flexing channel leg 804 outward, increasing the clearance of channel 806, and allowing the flange of the ladder rail to pass bend 805. Once the flange of the ladder rail is past bend 805, channel leg 804 can spring back to a locked position, where it can hold rail channel 800 to the ladder rail.

In some embodiments of the present disclosure, an adhesive 810 is utilized to secure ladder rail channels to ladder rails. In some examples, an adhesive is applied to inner surfaces of each rail channel web (in other words, the side of the channel web facing the channel space) prior to seating of the rail channel on a ladder rail. In some embodiments, said adhesive comprises a heavy duty double-sided tape or bonding tape. In other embodiments, other types of double-sided adhesive tapes are used. Upon seating the rail channel on a ladder rail, said adhesive may act to secure the rail channel to the ladder rail. In some embodiments, said adhesive acts in conjunction with the

Various embodiments of rail channel 800 are made having a thickness suitable to provide a degree flexibility that allows rail channel 800 to be seated upon a ladder rail while providing a degree of stiffness that allows rail channel 800 to remain secured to the ladder rail once seated thereon. A person of ordinary skill in the art having the benefit of this disclosure will understand that said thickness of various embodiments of rail channel 800 may depend on the material of construction as well as various dimensions of the rail channel.

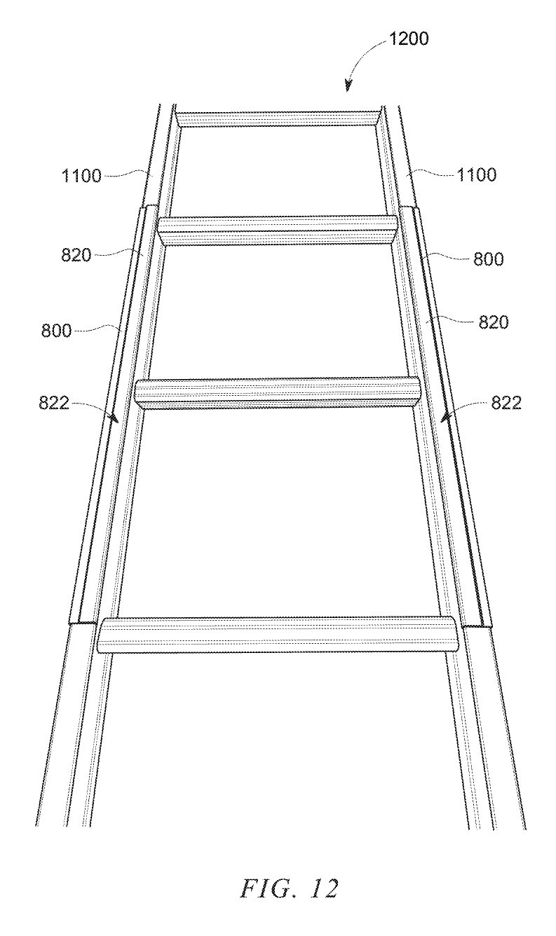

In operation, rail channels can be seated and locked onto a ladder rail. Referring to FIG. 11, embodiments of rail channel 800 may be seated on a ladder rail having opposing ladder rail flanges by first placing channel leg 801 over a first ladder rail flange 1101, such that said ladder rail flange 1101 is seated within channel 803. Thereafter, rail channel 800 can be pushed against the ladder rail 1100, causing a second ladder rail flange 1104 to be pushed against inner surfaces of channel leg 804, thereby flexing channel leg 804 outward and away from the second ladder rail flange 1104. Once channel leg 804 has flexed enough to provide sufficient clearance for the second ladder rail flange 1104 to pass by bend 805, channel leg 804 may spring inward, partially or completely to a locked position. Each ladder rail flange 1101, 1104 may then be held in place by a respective one of channel legs 801, 804, with the ladder rail 1100 seated within channel space 806. In one embodiment, spring tension in channel leg 804 against a ladder rail flange 1104 may provide a holding force to maintain the rail channel 800 connected to the ladder rail 1100. In one embodiment, channel leg 804 provides enough holding force such that sliding of the rail channel 800 along the length of the ladder rail 1100 is minimized. In embodiments, a second rail channel is seated upon a second ladder rail at or near the same height on the ladder rail by following similar operations as set forth above.

In some embodiments, an adhesive 810 is applied to each rail channel prior to seating. In some embodiments, rail channels are sold and/or distributed with an adhesive pre-applied to an inner surface of each rail channel web. In some embodiments, a double-sided adhesive tape is placed on an inner surface of each rail channel web during manufacturing and/or prior to sale and/or distribution of the rail channel. In such cases, seating of the rail channel to a ladder rail may be preceded by removal of a backing material from the adhesive tape, thereby exposing the sticky side of the tape, which can adhere to the ladder rail one the rail channel is seated thereupon. In some embodiments, installation of a ladder rail comprises applying an adhesive tape and/or adhesive material to the ladder rail and/or ladder rail channel prior to joining the two components together. As would be understood by a person of ordinary skill in the art having the benefit of this disclosure, it may be advantageous to use an adhesive that is rated for exterior use, as the ladder on which the ladder rails are installed could be used in various conditions including rain or snow.

FIG. 12 depicts a ladder 1200 with two ladder rail channels 800 seated thereon, as embodiments of the present disclosure may be used in practice. In embodiments, rail channels 800 are adapted to be seated on ladder rails 1100 with a relatively low profile, such that they do not interfere with closure of a hinged step ladder or storage of the ladder. In some embodiments, a rail channel comprises two channel legs, each having an inclination and/or shape similar to that of channel leg 804. In such embodiments, one or both channel legs may flex outward and then return by spring action as the rail channel is seated on a ladder rail.

Embodiments of the present disclosure comprise protective pad 820 affixed to top surface 808. Fixation of protective pad 820 to rail channel 800 may be by various techniques, such as with adhesive and/or with fasteners, for example. In embodiments, one or more exposed surfaces on protective pad 820, including top pad surface 822, may be textured.

The disclosed ladder rail channels may be adapted to secure to ladder rails, which may give added stability and safety to climber, may assist the climber to meet OSHA requirements, and may protect the structure on which the ladder lays. When a ladder is laid on a structure to extend above a roof line, for example, OSHA regulations require that the ladder extend 3 feet above the roof line. The disclosed ladder rail channels may be installed on a length of a ladder to provide contact points at the roof line while leaving a 3 feet extension of ladder above the roof line.

As set forth above, embodiments of ladder rail channels may include a variety of lengths. For embodiments that include ladder rail channels having a 24-inch length, said ladder rail channels may be attached to ladder rails at a position on the ladder such that the top of each ladder rail channel is approximately 24 inches below the top of each respective ladder rail. In this manner, when the ladder is leaned against a roof eave or other structure with three feet of the ladder extending above said structure, the ladder rail channel pad may contact the top of the structure at approximately the midpoint of the rail channel, thus providing a margin of safety should the structure be shorter or taller than estimated.

When moved, ladders can cause damage to the contact surface against which they are laying or bearing, such as gutters, walls, doors, and garage doors. Damage can also be caused to vehicles during transportation. The disclosed ladder rail channels may provide protective pads adapted to protect surfaces they lay against from contact damage. Advantageously the pads may be made from a durable resilient material such as rubber, foam rubber (such as “Styrofoam”), or a suitable elastomer or plastic material, although the scope of this disclosure is not limited to any particular material for pads on the disclosed ladder rail channels and bumpers.

Embodiments of the disclosed ladder bumpers further provide a ladder angle-setting protrusion (also referred to in this disclosure as an “ASP”) on the protective pads. In such embodiments, the ASP is a thickened portion of the protective pad where a planar surface is provided on the ASP. The planar surface is set ai a predetermined angle to the longitudinal axis of the protective pad. Thus, when the disclosed ladder bumpers are installed and engaged on a ladder's rails and rungs; the planar surfaces on the ASPs may confront the upper contact surface on the structure against which the ladder is to be laid. The predetermined angle of the planar surface is such that when the planar surface of the ASP is brought into snug contact against the structure's contact surface (assuming the structure's contact surface is substantially vertical), the ladder may be set against the structure at a desired vertical angle. In some embodiments, the desired vertical angle will be 75.5 degrees, conforming to OSHA requirements. However, this disclosure is not limited to 75.5-degree deployments, and the ASP on a particular bumper protective pad may be manufactured to set any angle, as required.

The protective pads on the disclosed ladder rail channels may also, in some embodiments, be textured to provide additional slip resistance. It is well understood that one of the dangers of ladder use is that the ladder may slip or slide horizontally against its upper contact surface and fall while a climber is on the ladder. This is particularly the case if the ladder is not (or not yet) tied off or otherwise secured at the top end. The durable resilient material from which the ladder bumper protective pads are made will inherently provide slip resistance against contact surfaces. Embodiments in which the protective pads are textured may provide additional slip resistance.

The disclosed ladder rail channels may also be installed on the legs of a step ladder to protect surrounding surfaces (such as walls, doors, etc.) from accidental “knocks” and “bumps” while moving the step ladder. It is well known that step ladders should be moved carefully within confined spaces to avoid such accidental contact damage. The disclosed ladder rail channels can be installed on the legs of a step ladder and the protective pads on the rail channels can cushion against potential damage to surrounding structures caused when the step ladder is moved.

The disclosed ladder rail channels may also optionally include ladder stakes. Ladder stakes may also help with stability. Ladder stakes can stabilize ladders on hill sides and on surfaces other than concrete or rock. This added stability may provide added protection for the climber. The stakes can reduce the risk of injury if climber is climbing alone. Ladder stakes can also be manufactured to assist with setting the ladder at a desired vertical angle for safe ladder placement.

Climber safety may be further enhanced by the secure and robust manner in which the disclosed ladder rail channels engage a ladder. Conventional products are typically flimsy and unreliable. Straps on conventional bumpers can loosen, can impede climbing, and may even shift relative to the ladder, rendering the ladder unstable in place and therefore unsafe. If a climber starts to lose balance and grabs onto of the disclosed ladder rail channels, however, the rail channel(s) may not separate from the ladder, shift, move, or rotate relative to the ladder, thereby adding to the safety of the climber.

It therefore may be a technical advantage of the disclosed ladder rail channels to enhance climber safety. Aspects and features of the disclosed bumpers may enhance climber safety generally. Embodiments of the disclosed bumpers may further assist with, and even encourage, compliant OSHA ladder use. A further technical advantage is that the disclosed ladder bumpers may reduce greatly (and may even prevent) contact wear or damage to surfaces on structures against which the ladder lays or rests.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed:

1. A ladder rail channel comprising:
two opposing elongate channel legs separated by and connected to an elongate channel web, the two channel legs comprising a first channel leg and a second channel leg, wherein:
the first channel leg comprises a proximal section proximate to the channel web, a distal section situated away from the channel web, and an intermediate transition section situated between and joining the proximal section and the distal section;
the proximal section defines a proximal clearance gap between said proximal section and the second channel leg;
the distal section defines a distal clearance gap between said distal section and the second channel leg; and
the clearance gap of the distal section is smaller than the proximal clearance gap;
a protective pad affixed to the ladder rail channel on a surface of the channel web opposite the two channel legs.

2. The ladder rail channel of claim 1, wherein the protective pad contacts the channel web along most of the length of the ladder rail channel.

3. The ladder rail channel of claim 1, wherein the transition section comprises a bend in the first channel leg.

4. The ladder rail channel of claim 1, wherein the second leg and a portion of the channel web form a C-shaped extension.

5. The ladder rail channel of claim 1, wherein the second leg comprises:
a second proximal section proximate to the channel web, a second distal section situated away from the channel web, and a second intermediate transition section situated between and joining the second proximal section and the second distal section, wherein:
the second proximal section defines a second proximal clearance gap between said second proximal section and the second channel leg;
the second distal section defines a second distal clearance gap between said second distal section and the second channel leg; and
the second distal clearance gap is smaller than the second proximal clearance gap.

6. The ladder rail channel of claim 1, wherein the protective pad has an exposed surface that is textured.

7. The ladder rail channel of claim 1, wherein the ladder rail channel has a length of approximately 24 inches.

8. A pair of ladder rail channels and a ladder, the ladder including two ladder rails separated by a plurality of spaced-apart ladder rungs, wherein:
each ladder rail channel comprises:
two opposing channel legs separated by and connected to a channel web, the two channel legs comprising a first channel leg and a second channel leg, wherein the first channel leg is adapted to apply spring tension toward the second channel leg to grip one of the ladder rails; and
a protective pad affixed to the channel web such that the pad contacts the channel web; and
each ladder rail channel is seated on a corresponding one of the ladder rails.

9. The pair of ladder rail channels and the ladder of claim 8, wherein the first one of the two opposing channel legs comprises:
a proximal section proximate to the channel web, a distal section situated away from the channel web, and an intermediate transition section situated between and joining the proximal section and the distal section, wherein:
the proximal section defines a proximal clearance gap between said proximal section and the channel leg;
the distal section defines a distal clearance gap between said distal section and the proximal clearance gap; and
the distal clearance gap is smaller than the proximal clearance gap.

10. The pair of ladder rail channels and the ladder of claim 8, wherein each one of the ladder rails further comprises two opposing flanges, wherein a first of the two opposing flanges of the corresponding one of the ladder rails is gripped by the first channel leg of each ladder rail channel.

11. The pair of ladder rail channels and the ladder of claim 10, wherein:
the second leg of each one of the ladder rail channels and a portion of the web of each one of the ladder rail channels form a C-shaped extension and
a second of the two opposing flanges of the corresponding one of the ladder rails is gripped by the C-shaped extension of each ladder rail channel.

12. The pair of ladder rail channels and the ladder of claim 8, wherein each ladder rail channel has a length of approximately 24 inches.

13. The pair of ladder rail channels and the ladder of claim 8, wherein each ladder rail channel further comprises a protective pad that contacts its respective channel web along most of the length of said ladder rail channel.

14. The pair of ladder rail channels and the ladder of claim 13, wherein the protective pad has an exposed surface that is textured.

15. A method of using a ladder, comprising:
providing two ladder rail channels and a ladder, the ladder including two ladder rails separated by a plurality of spaced-apart ladder rungs, each ladder rail having two opposing flanges along its length, and each one of the two ladder rail channels comprising:
two opposing elongate channel legs separated by and connected to an elongate channel web, the two channel legs comprising a first channel leg and a second channel leg, wherein:
the first channel leg comprises a proximal section proximate to the channel web, a distal section situated away from the channel web, and an intermediate transition section situated between and joining the proximal section and the distal section;
the proximal section defines a proximal clearance gap between said proximal section and the second channel leg;
the distal section defines a distal clearance gap between said distal section and the second channel leg; and
the clearance gap of the distal section is smaller than the proximal clearance gap;
seating a first one of the two ladder rail channels on a first one of the two ladder rails by:
positioning the first ladder rail channel onto the first ladder rail such that the first ladder rail is placed between the first channel leg and the second channel leg of the first ladder rail channel;
applying a seating force on the first ladder rail channel toward the first ladder rail, thereby causing a corresponding first one of the two opposing flanges of the first ladder rail to slide past the distal section of the first channel leg of the first ladder rail channel and push against the first channel leg of the first ladder rail channel while a corresponding second one of the two opposing flanges of the first ladder rail pushes against the second channel leg of the first ladder rail channel, thereby causing the first channel leg of the first ladder rail channel to flex away from the first flange of the first ladder rail; and
continuing to apply the seating force on the first ladder rail, thereby causing the first channel leg of the first ladder rail channel to spring to a locked position, whereby the first channel leg of the first ladder rail applies a spring tension holding force upon the first flange of the first ladder rail, thereby securing the first ladder rail channel to the first ladder rail.

16. The method of claim 15, wherein:
the second channel leg of each one of the ladder rail channels and a portion of the web of each one of the ladder rail channels form a C-shaped extension;
positioning the first ladder rail channel onto the first ladder rail further comprises positioning the second flange of the first ladder rail within a gap defined by the C-shaped extension.

17. The method of claim 15, further comprising seating a second one of the two ladder rail channels on a second one of the two ladder rails by:
positioning the second ladder rail channel onto the second ladder rail such that the second ladder rail is placed between the first channel leg and the second channel leg of the second ladder rail channel; and
applying a seating force on the second ladder rail channel toward the second ladder rail, thereby causing a corresponding first one of the two opposing flanges of the second ladder rail to slide past the distal section of the first channel leg of the second ladder rail channel and push against the first channel leg of the second ladder rail channel while a corresponding second one of the two opposing flanges of the second ladder rail pushes against the second channel leg of the second ladder rail channel, thereby causing the first channel leg of the second ladder rail channel to flex away from the first flange of the second ladder rail;
continuing to apply the seating force on the second ladder rail, thereby causing the first channel leg of the second ladder rail channel to spring to a locked position, whereby the first channel leg of the second ladder rail applies a spring tension holding force upon the second flange of the second ladder rail, thereby securing the first ladder rail channel to the first ladder rail.

18. The method of claim 15, wherein each ladder rail channel further comprises a respective protective pad that contacts its respective channel web along most of the length of said ladder rail channel.

19. The method of claim 18, wherein each protective pad has an exposed surface that is textured.

20. The method of claim 18, wherein each ladder rail channel has a length of approximately 24 inches.
